(19) United States
(12) Patent Application Publication
(10) Pub. No.: US 2015/0360768 A1
(43) Pub. Date: Dec. 17, 2015

(54) Mounting assembly for fully automatic slat

(71) Applicant: Troy A. Woodland, Walhalla, SC (US)

(72) Inventor: Troy A. Woodland, Walhalla, SC (US)

(21) Appl. No.: 14/120,653

(22) Filed: Jun. 12, 2014

(51) Int. Cl. B64C 13/28; B64C 3/28

(52) U.S. Cl. CPC B64C 13/28; B64C 3/28

(57) ABSTRACT

A slat mounting assembly comprising brackets specifically positioned at opposing points, respectively on the main spar and the slat spar on a center line connecting the slat and main spar combined with design and structure of the brackets that maintains a parallel relationship between pairs of axles in a unit such that the slat deploys and retracts automatically, freely, without binding and is securely attached to the wing.

### PRIORITY CLAIM

This U.S. patent application claims priority of U.S. Provisional application No. 61/967,305 filed Jun. 28, 2013 and incorporated herein by reference.

### FIELD OF THE INVENTION

The invention is in the general field of aircraft flight control surfaces, more specifically in the field of wing slats and slots, and specifically it relates to a novel assembly to attached a fully automatic wing slat with a slot to the leading edge of the wing.

### INTRODUCTION

The physical principles of lift generated are well known and unquestioned. A brief review of these principles provides an essential foundation for understanding the function of the wing slat and slot, particularly in relation to automation deployment and retraction of the slats. These basic principles cannot be separated from the claims made or the technology of the examples presented in the following specification.

An airfoil (wing) generates lift as it moves through the air (actually as air moves over the airfoil). The lift generated is a function of the cross section shape or geometry (camber) of the wing and the angle of attack of the wing. Increasing the area of a wing of a given shape (camber) will increase lift proportionately-double the area/double the lift; however, lift per unit of wing area, is increased only by increasing the camber for most aircraft.

### BACKGROUND TECHNOLOGY

### Introduction

Lift is generated by reduced pressure on the upper surface of the wing compared with the lower surface. As the wing moves through the air, the path across the upper surface, due to the camber of the wing, is longer than the cord line or path over the lower surface; thus, the air moves relatively faster across the upper surface thereby reducing pressure on the upper surface compared with the lower surface following Bernoulli's principle. Newton's Third Law, “for every action, there is an equal, opposite reaction” cannot be ignored: air pressure on the upper surface is reduced; relatively, air pressure is increased, yielding lift.

FIG. 1A an FIG. 1B illustrate basic elements of an aircraft wing and provides the foundation for the invention. The cross section of a wing 101 (or any air foil) comprises a leading edge 102, a trailing edge 103, an upper surface 104, a lower surface 105, and the chord 106 (or chord line), the width of the wing from the leading edge 102 to the trailing edge 103.

The camber 107 of the wing is the curve of the upper surface (and lower surface) of the wing from the leading edge 102 to the trailing edge 103. The mean (or average) camber line 108 is based on the points midway between the upper surface 104 and lower surface 105 of the wing. The thickness 109 of the wing varies along the chord line 106 and is measured in one of two ways: distance perpendicular to the camber line 108 (the American convention) or distance measured perpendicular to the chord line 106 (the British convention). Maximum thickness, measured as percentage of the chord, and point or location of maximum thickness, also expressed as percentage of the chord greatly affect the shape of the wing.

The width of the wing or chord line 106 and the mean camber line 108 determine the amount of camber 110 and its distribution along the cross section of the wing. The amount of camber 110 is a critical factor in the design and in determining lift of any specific wing; however, such theoretical considerations are beyond the scope of this disclosure.

The lift generated varies with the camber of the wing and the angle of attack, defined as the angle at which the air strikes the leading edge of the wing, or the angle between the chord line and a horizontal line. Lift is generated as a product of the relative speeds passing over the upper surface of the wing (the longer surface because of the camber of the wing) compared with the lower surface that results in relative lower pressure on the upper surface than on the upper surface, or, produces lift. For optimum efficiency, the air should flow smoothly over both surfaces; however as angle of attack increases, or as air speed decreases, the air flow tends to separate from the surface of the trailing edge of the wing forward. As the separation increases (moves further forward), lift is lost to the extent that the wing cannot produce adequate lift to support itself; the wing stalls, and normal flight cannot be maintained, and the aircraft enters a spin. Steps must be taken to “break” the stall, regain adequate lift, and return to normal flight. This initially requires leveling the wings and increasing air speed by decreasing the angle of attack. Stall and spin recovery are part of basic flight instruction for most student pilots.

FIG. 1C illustrates the cross section of a wing 101 with a very slight upward pitch or angle of attack 111 (3 to 6 degrees, for example.) Air flow over the upper surface 104 indicated by lines 112 is smooth 113 across virtually the full width (cord line 106) of the wing. The wing is generating near maximum lift, even though it is a relative level flight attitude. By contrast, FIG. 1D illustrates the cross section of a wing 101 with a relatively great upward pitch (angle of attack 111 (15 to 18 degrees. Air flow indicated by lines 115 separates from the upper surface of the wing towards the leading edge 102, there by reducing lift. The greater the angle of attack 111 (the steeper the pitch), the greater the loss of lift, until the wing stalls, and the nose of the aircraft pitches downward into a spin.

No absolute, maximum angle of attack can be cited for all aircraft; however for many general aviation aircraft 15 to 18 degrees is commonly recognized as a reasonable limit for stall avoidance, and this limit may be reduced under a variety of conditions (wind speed and direction in relation to the direction of flight). Decreasing stall speed and increasing lift at lower air speeds may be desirable for a variety of reasons. In general, lower stall speeds can be equated to shortened take-off and landing distances, thereby increasing the number of suitable airports (or emergency landing sites) available to any given aircraft model, assuming adequate pilot skill and experience). In addition, slow flight is desirable, if not necessary, for a variety of activities, including, but not limited to forest, wildlife, and range land surveys, pipe line inspections in remote areas, and search and rescue activities. Finally, in an era of emphasis on speed, controllable, slow flight in appropriate aircraft is enjoyed by many pilots.

### High Lift Devices

New wing designs that combine slow flight with reasonable cruising speeds and fuel efficiency will continue to be developed. A demand to modify or retro-fit existing aircraft (or at least wing design) with devices that have the effect of increasing camber without an excessive increase in drag or other flight characteristics is clearly desirable, and this concept is not new.

Deployable flaps on the wings involving an amazing array of configurations constitute widely recognized devices that increase lift (camber) and decrease stall speed and are effective in reducing take-off and landing speed and distances for virtually all categories of fixed wing aircraft. The significance and cannot be denied; however, even a superficial discussion of these trailing edge high lift devices is beyond the scope of technology considered in the present invention and disclosure.

Leading edge slats and associated slots are lift enhancing devices functionally similar to flaps, but with to slats connected to and part of the leading edge of the wing. Slats and slots are not as common in smaller, general aviation aircraft as flaps, but interest in these high lift devices is growing. Three categories of slats are recognized: automatic slats that are flush with the leading edge of the wing and are deployed as pressure on the leading edge of the leading edge of the slat is reduced as stall speed is approached and that may require some mechanical assistance to retract when air speed increases (or angle of attack is reduced); fixed slats that are permanently deployed or extended from the leading edge of the wing and are a significant source of excess drag in normal cruise flight; and mechanical (including pneumatic and hydraulic systems) slats that are deployed and retracted by the pilot as needed or desired. The following discussion is limited to automatic slats, technology of the current application.

FIGS. 2A and 2B illustrate the basic structure of a slat, omitting the type of slat and how it is connected to the wing. Slats are aerodynamic surfaces on the leading edge of the wing. The following discussion focuses on automatic slats, although basic principles apply to other types of slats.

FIG. 2A shows the cross section of a wing 101 with the slat 217 fully retracted as it would be in normal flight. The inner surface 222 of the slat 217 is generally in contact with the upper surface of the wing 104. The slat 217 comprises a leading edge 218, an upper, trailing edge 219, lower trailing edge 220, the outer surface 221, and the inner surface 222. The slat, when fully retracted, has minimal effects on the wing aerodynamics, drag or lift.

The slat is fully deployed when air speed is reduced and/or the angle of attack is increased to near stall conditions. FIG. 2B illustrates the cross section of a wing with the slat fully deployed (or extended). When deployed, the slat moves outward, away from the leading edge 102 of the wing 101 and angularly downward on a flat plane. Deployment of the slat increases the chord line 106 with the length of the airfoil (wing plus slat) now chord line 106A. In addition, the slightly lowered leading edge of the slat (compared with the wing, when the slat is retracted) increases the camber slightly, as does the increase in chord length. Both of these contribute to increased lift, or reduced stall speed.

A slot 223, defined as the opening between the inner surface 222 of the slat 217 and the corresponding upper surface of the wing 104, is formed when the slat 217 is deployed. The slot 223 has a first or lower opening 225 and a second or upper opening 226. The first, larger opening is defined or limited by the lower trailing edge 220 of the slat 223 and a corresponding point on the leading edge 104A of the wing 101. The second, smaller opening 226 is similarly defined and limited by the upper trailing edge 219 of the slat and by a line parallel to the upper trailing edge 219 of the slat 223 from a corresponding point on the upper surface 104 of the wing 101 that is horizontally parallel to the upper trailing edge 219 of the slat. The slot 223 narrows from the first opening 225 to the second opening 226 as seen in FIG. 2C. The area between the first opening 225 and the second opening 226 is frequently referred to as the nozzle 227.

Air flowing from the leading edge 217 along of the lower trailing edge 220 of the slat flows, at least in part, from the first or lower opening 225 upward, through the nozzle 227 and exits through the upper opening 226. As a result of the narrowing of the nozzle from the lower opening 225 to the upper opening 226, the velocity of air flowing from the second opening is greater than the velocity of the air traveling over the leading edge of the wing (or slat) and flowing along the upper surface of the wing. The flow of air with accelerated velocity flows smoothly over the upper surface 104 of the wing 101 because of its accelerated velocity (does not separate from the wing surface) thereby effectively increasing air speed/preventing stall conditions.

The automatic slats extend (are deployed) in response to decreased lift resulting from either increased angle of attack or reduced air speed. The slats are retracted automatically (frequently including a mechanical assist) when lift increases.

### PRIOR ART

The practical application of wing slats traces to the second decade of the 20th Century. The earliest technology centered on fixed slats. In 1918, Gustav Lachmann applied (unsuccessfully) for a German patent on a wing slat. The technology has grown and changed with the growth of the aircraft industry, but the basic functions of the slat have remained relatively unchanged: flight safety/stall avoidance at low air speed and increased angle of attack.

Slat technology has been patentable subject matter for over 90 years in the United States. Two of the earliest patents in this field were issued to Page, who worked with Lachmann. U.S. Pat. No. 1,353,666 issued Sep. 20, 1920 and titled “Wing and Similar Member of Aircraft” disclosed slat construction concepts to reduce air turbulence near the leading edge of the wing and its negative effect on lift. Designs were based on the premise that the slat or slats must have an angle of incidence less than the angle of incidence of the wing. This results in design dimensions and limitations for a specific wing. A wing could have more than one slat, and the slats were mechanically operated (deployed and retracted) by the pilot. The second patent, U.S. Pat. No. 1,394,344, also titled, “Wing and Similar Members of Aircraft,” was issued Oct. 18, 1921. The '344 patent remedied design deficiencies not recognized in the '666 patent. The axes of the pivots at the ends of each arm of the hinge that controls slat extension are parallel in the '666 patent. The base of the slat is approximately level with the base of the wing, with an angle of incidence less than the angle of incidence of the wing. Subsequent to the '666 patent, the inventor found that a more effective slat was formed when each axes was at a right angle to its corresponding chord. his results in non-parallel axes, but in desired slot dimensions and adaptation to the connection of the swing arm to the slat accommodate the non-parallel relationship between the axes.

U.S. Pat. No. 6,015,117 titled “Variable Camber Wing Mechanisms” and issued to Broadbent on Jan. 18, 2000 discloses and claims a swing hinge device in which the pivotal axle that connects the swing arm to the wing is not parallel to the comparable axle connecting the swing arm to the slat, and in which the connection of the swing arm to the slat includes a second pivot bearing, a swivel bracket, and a swivel bearing. In addition, sliding pieces in the nose (leading edge) area of the wing close the opening in the wing through which the swing arm travels to deploy the slat; the sliding pieces retract to allow the swing arm reverse direction across the opening when the slat is retracted. This is not an automatic slat.

In addition to the technology summarized above, slat and slat control, generally in high speed aircraft in which reduced speed for both take-off and landings is the focus of a variety of US patents. The following reflect a sample of the scope of growth of this art in the past 60 years. U.S. Pat. No. 2,600,527 issued Jun. 17, 1952 addresses the arrangement of slat operating linkages in wing structures to minimize damage from vibrations and air turbulence. U.S. Pat. No. 6,789,769 issued Sep. 14, 2004, describes selectively controlled rows of bristles to control/reduce air flow noise and effects on slats. Finally, consider U.S. Pat. No. 8,276,852 issued Oct. 2, 2012 that provides for a low noise aircraft wing slat system. A cove-filled wing slat is employed with a moveable leading edge element of an aircraft wing to produce a high lift system.

### SUMMARY OF THE INVENTION

### Goals and Objectives

A first goal and objective of the invention is a mounting assembly that securely connects a slat to the wing of an aircraft.

A second goal and objective of the invention is a mounting assembly that allows the slat to function fully automatically, in response to aerodynamic conditions resulting from changes in air speed or aircraft angle of attack.

A third goal and objective of the invention is a mounting assembly that is highly dependable and that functions consistently and smoothly.

A fourth goal and objective of the invention is a slat mounting assembly wherein rotatable axles positioned at the wing and spar ends of the structural arm of the assembly are mutually parallel and are at a right angle to the center line of the structural arm, and the structural arm is aligned on the center line connecting the center point of the wing (main) spar and the slat spar and also, in which the rotatable axles are with and pivot around the center point of a corresponding bracket wall, and the axles are maintained in their mutually parallel orientation throughout deployment and retraction of the slat.

A fifth goal and objective of the invention is a slat mounting assembly in which the slat is in a forward, downward orientation along a plane defined by the line connecting the center points of the round wing spar and the round slat spar, which line also is the center of the structural arm of the mounting assembly.

A sixth goal and objective of the invention is a mounting assembly in which the structural arm is rotatably (or pivotly) connected to the slat spar and the main spar through the axles that rotate against a bearing or bushing assembly positioned as part of the side walls of the slat spar bracket and the main spar bracket, and where both brackets are mounted on bases the shape (arc) of which is identical to the shape (arc) of the main or slat spar such that when positioned on the corresponding slat or main spar, the structural arm of the assembly is aligned on the line connecting the center points of the circular spars and the effective length of the structural arm is the minimum distance between the two spars.

A final goal and objective of the invention is a structural arm modified to comprise at least two segments and any of a variety of coupling devices that will allow the overall length to be adjusted during final assembly to ensure critical parallel and right angle relationships are maintained throughout normal flight, deployment and flight with slats deployed, and retraction of flaps.

### SUMMARY

These and other goals and objectives are achieved by a mounting assembly for a fully automatic slat in which a pair of mounting assemblies are used to secure the main (wing) slat and to the slat spar, thereby securely connecting the spars (and wing to the slat) and also to ensure fully automatic dependable deployment and retraction of the slat in response to aerodynamic changes associated with air speed and angle of attack of the aircraft in flight and consistent performance of the slat in all phases of flight; each individual mounting assembly comprises a slat spar mounting bracket, a main spar mounting bracket, and a slat hinge arm, and the slat hinge arm comprises a structural arm unit with a first and a second end each of which ends comprises a rotatable (or pivotal) axle; the pivoting axles are parallel to each other and are at a right angle to the center of the functional arm; both the slat spar mounting bracket and the main spar mounting bracket comprise a base, two side walls, and a back wall; the base of the slat spar bracket is curved to fit precisely the curve of the slat spar, and the curve of the main spar bracket is similarly adapted to the main spar; this ensures optimum contact and a solid connection between the bracket and corresponding spar; the side walls and back wall are connected to the base of the respective spar bracket, and each side wall further comprises an axle pivot unit; the axle pivot units of each pair of side walls of bracket is positioned at a point on the side wall such that members of each pair of pivotal axles are mutually parallel and are at a right angle to the longitudinal centerline of the pivotal arm unit; the side walls and back wall plus the pivot unit incorporated into each side wall form a pivot housing unit; each end of a pivotal axle engages the bearing unit and opposing pivot units are connected by a bolt that traverses the axle and connected pivot units; the assembly further comprises a structural arm, the length of which may be adjusted in the final steps of assembling the air craft.

### BRIEF DESCRIPTION OF THE DRAWINGS

FIGS. 1A,B,C, and D and FIGS. 2A,B, and C illustrate basic technology and principles of lift to which the invention is related. The remaining Figures apply specifically to the invention.

FIG. 1A illustrates the cross section of a wing with the chord line indicated.

FIG. 1B illustrates the cross section of FIG. 1 showing both the chord and camber line.

FIG. 1C illustrates the effect of angle of attack (increased pith) on the chord line and air flow of the cross section of a wing.

FIG. 1D illustrates the effects of increased pitch, compared with FIG. 1C, on chord line and air flow over cross section of a wing.

FIG. 2A illustrates the cross section of a wing with slat fully retracted.

FIG. 2B illustrates the cross section of the wing of FIG. 2A with the slat fully deployed.

FIG. 2C illustrates the cross section of a wing with the mounting assembly for a fully automatic slat fully deployed.

FIG. 3A is a schematic, 3-dimension view of the mounting assembly fully extended.

FIG. 3B illustrates the mounting assembly fully retracted and connected to the main and slat spars.

FIG. 3C illustrates the mounting assembly of FIG. 3B fully extended or deployed.

FIG. 4A illustrates cross section of wing with mounting assembly assembly connected to wing and slat spars and slat fully deployed.

FIG. 4B shows cross section of FIG. 4A with slat fully retracted.

FIG. 4C is a schematic diagram of movement of slat and mounting from fully retracted to fully deployed position.

FIG. 5A illustrates the slat spar bracket.

FIG. 5B illustrates the wing spar bracket.

FIG. 5C is a side view showing details of slat hinge arm.

FIG. 5D is a top view illustration of slat arm.

FIG. 5E is a diagram showing dimensions of elements of the assembly.

FIG. 5F is a diagram of details of slat hinge arm positioned in pivot housing unit.

FIG. 5G is a diagram of axle pivot with slat hinge arm engaged.

FIG. 5H provides an example of modified, adjustable slat hinge arm.

FIG. 5I shows an additional example of a modified slat hinge arm.

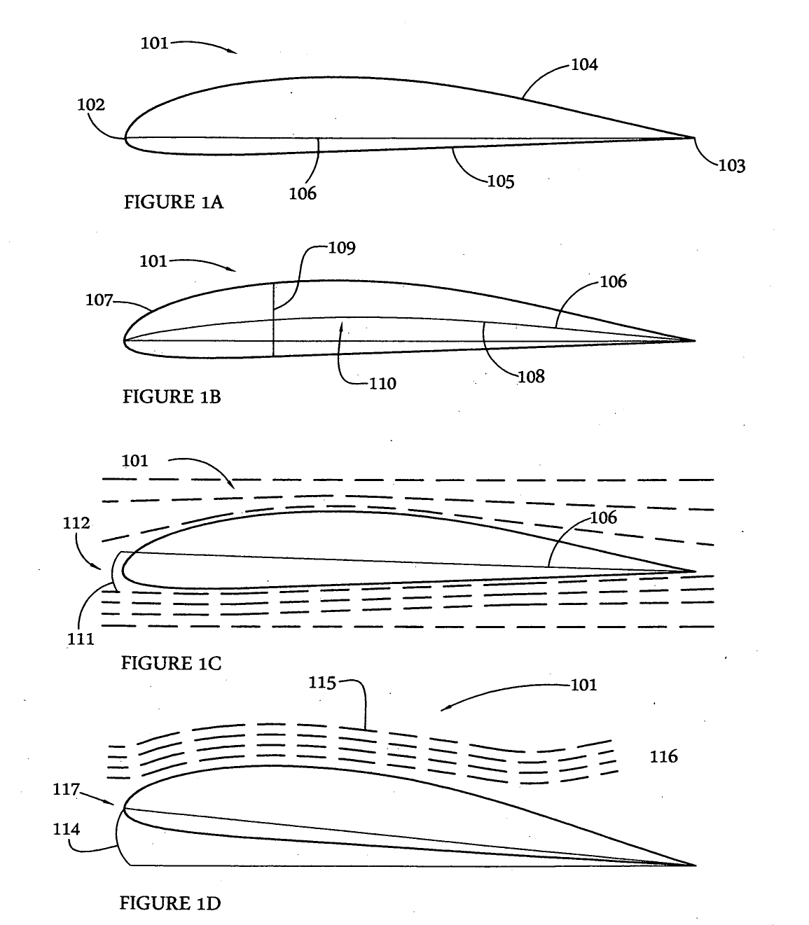

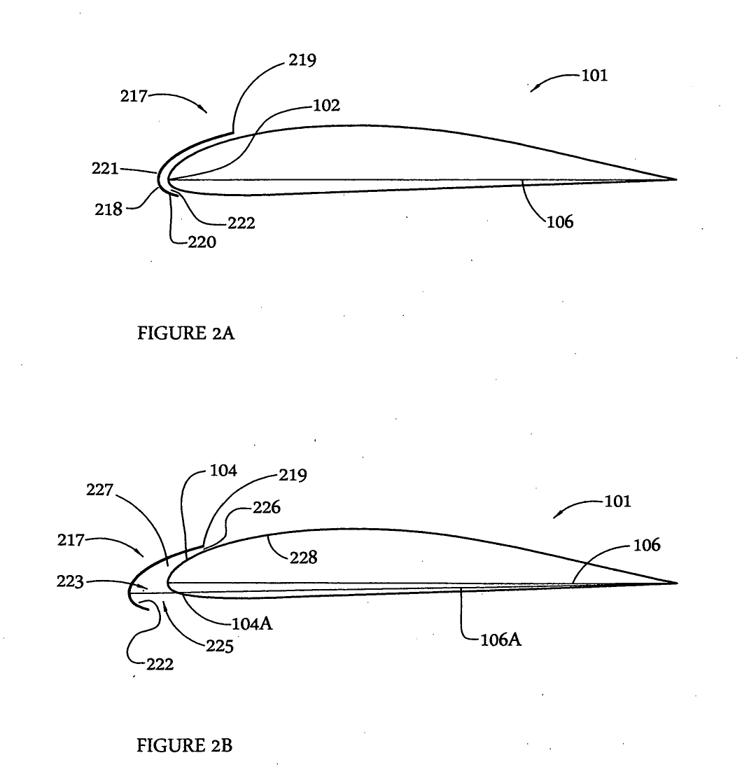

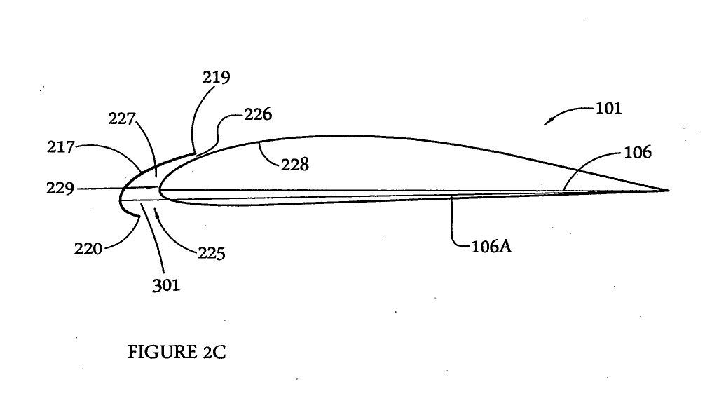

### FULLY AUTOMATIC SLAT MOUNTING ASSEMBLY

The mounting assembly for a fully automatic slat has two major functions. First, it must ensure stable, secure attachment of the slat to the wing. Second, it must allow fully automatic deployment and fully automatic retraction of the slat, deployment/retraction without any mechanical (including electric, hydraulic, or pneumatic) pilot operated system. Slat deployment occurs when the air speed is reduced to an eminent stall condition, frequently caused by an increased angle of attack, but equally probable for any slow speed flight operation, including short field takeoff and landings. Slat retraction to normal (cruise) flight conditions occurs automatically, reaches/exceeds a critical level, above stall speed.

How the fully automatic slats satisfy these two conditions is best explained by first considering the basic components of the assembly, in a top view of the isolated assembly, and next examining the assembly as it is attached to the wing and slat in the retracted position and then in the fully deployed configuration.

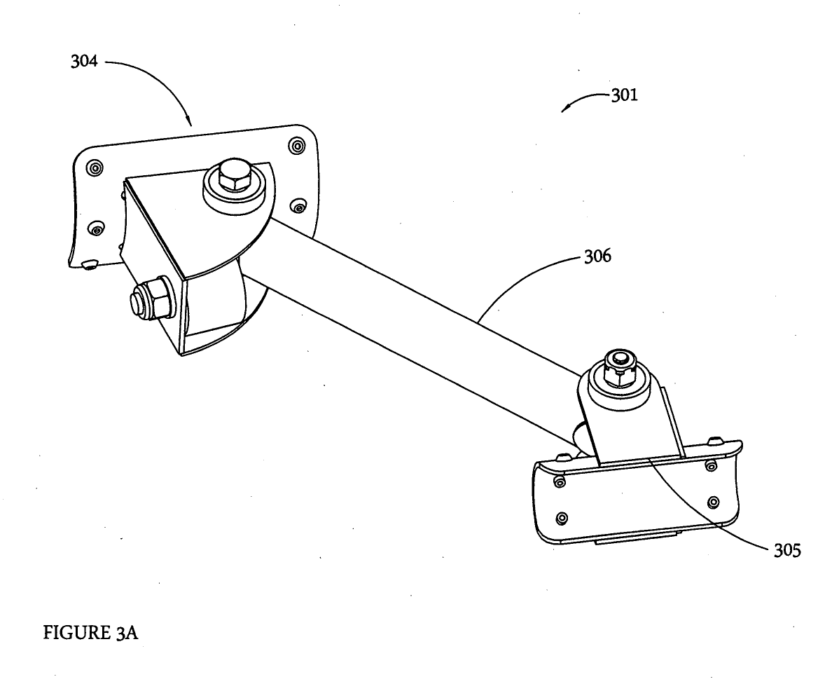

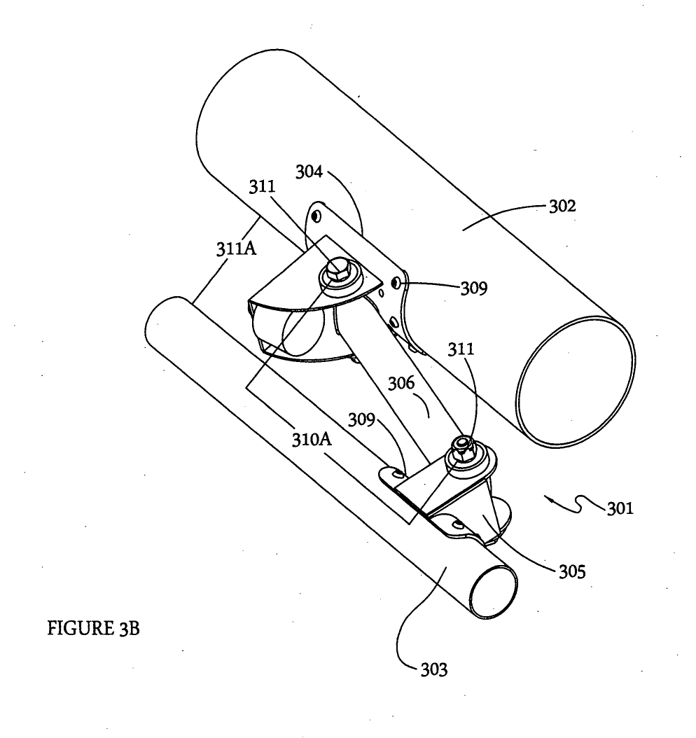

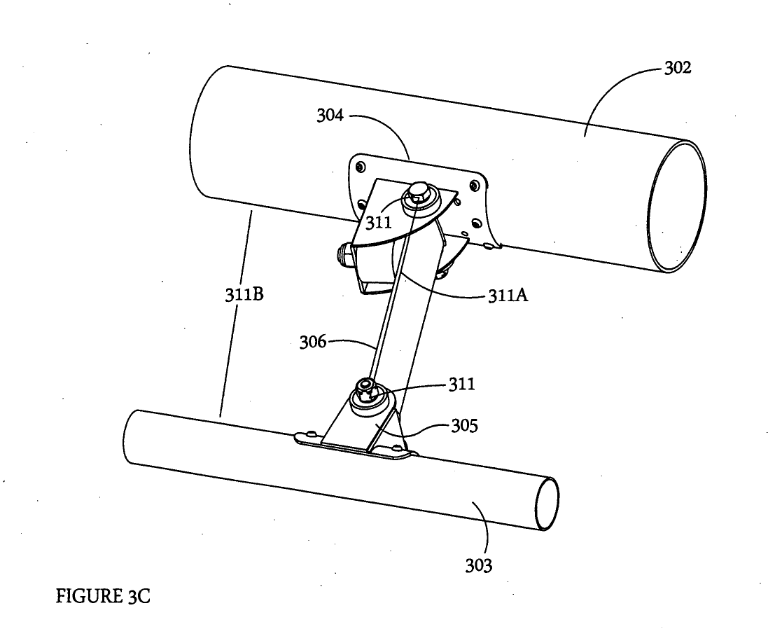

FIG. 3A provides a schematic, 3-dimensional view of an individual, automatic slat mounting assembly 301. The mounting assembly 301 comprises three, major components. Two mounting brackets 304 and 305 and a hinge arm 306. The main spar bracket 304 is slightly larger and structurally, slightly more complex than the slat spar bracket 305, as explained below. The slat hinge arm 306 is mechanically securely connected to both the wing main spar 302 and to the slat spar 303. The main spar bracket 304 connects the automatic slat mounting assembly 301 to the main spar 302 and the slat spar 303 connects the mounting assembly 301 to the slat spar 303. Both brackets, 304 and 305, are connected to the corresponding spar with stainless steel rivets, or comparable fasteners. The slat hinge 306 connects the main spar 302 to the slat spar 303. As illustrated in FIG. 3B, the slat is in the fully retracted position, as it would be in normal flight. The slat hinge arm; 306 is nearly parallel to both the main spar 302 and the slat spar 303, respectively.

The distance 311A between the main spar 302 and the slat spar 303 is effectively no greater than the height of the larger, main spar bracket 304, varying by way of example, not limitation from 1.5 to 4.0 in (3.8 to 10.2 cm). The horizontal distance 311C between bracket center points 311A and center point 311B is equal to the length 310A of the slat hinge.

As one of average skill in the art understands, both the left and right wing have a slat, and members of a pair of slats are independent as are the right and left wing slats. Each slat is connected to the wing by a pair of mounting assemblies. The mounting assemblies are identical; therefore, only the structure of one is illustrated and explained in the following, with one exception that is clearly noted and fully explained.

FIG. 3C illustrates the mounting assembly 301 in its fully deployed position. The main and slat spars 302 and 303, the main spar bracket 304 and the slat spar bracket 305 remain as described for FIG. 3B. The change in configuration from fully retracted to fully deployed is obvious in that the slat arm hinge 306 is nearly vertical to the main and slat spars 302 and 303 respectively, compared with the retracted configuration in FIG. 3B, and the horizontal distance between the two bracket centers 311A and 311B is negligible; the distance between the main spar 302 and slat spar equals the length 306A of the slat hinge arm 306.

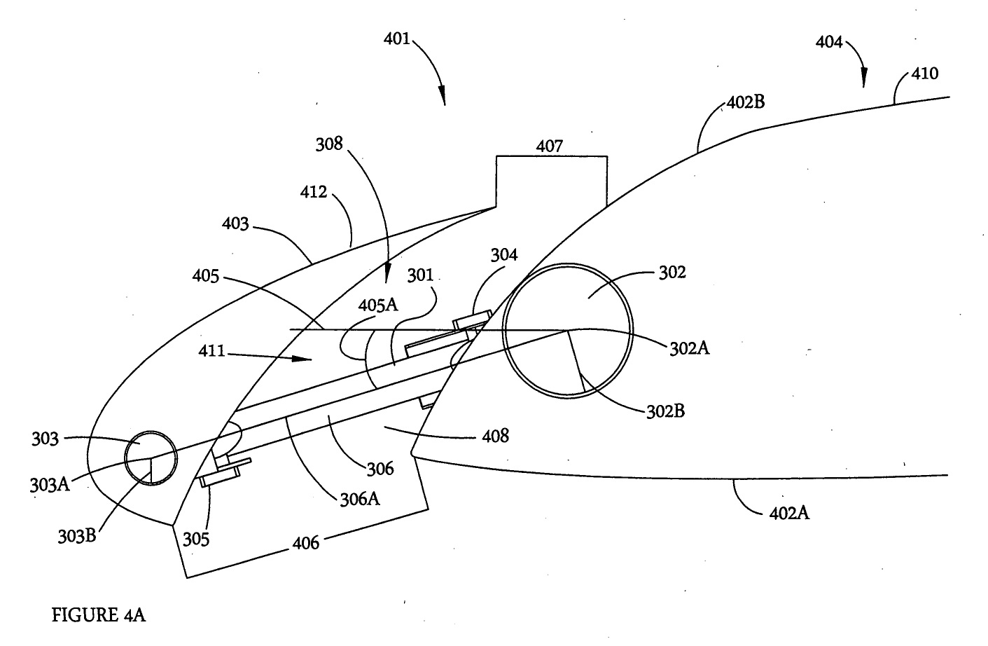

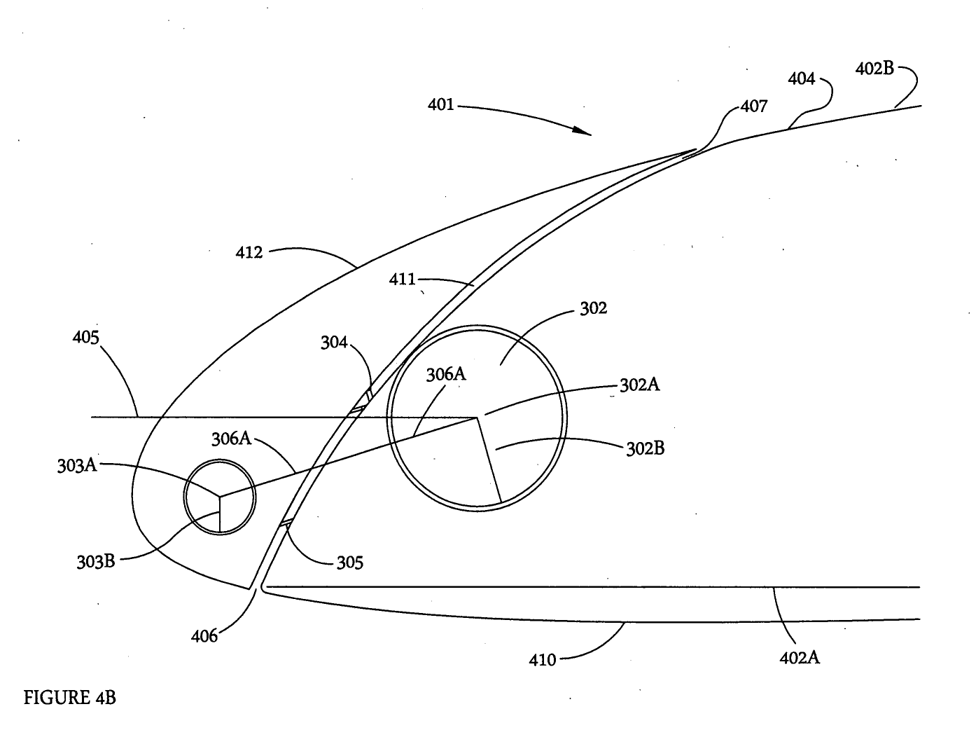

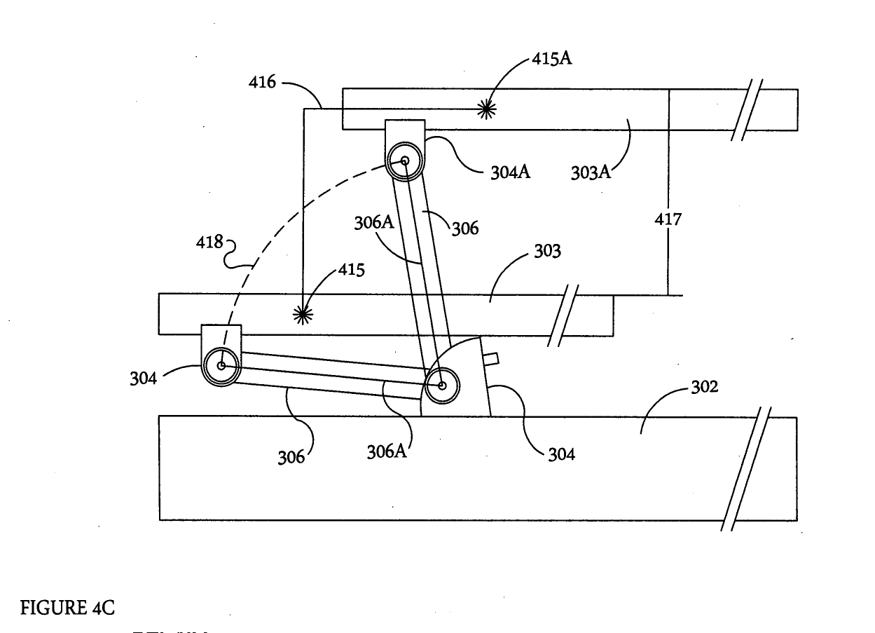

FIG. 4A is cross section view 401 of the wing 404 with the slat 403 fully deployed. A horizontal reference line 405 extends outward from the center point 302A of the main spar 302. Line 306A is the center line of the slat hinge arm 306 and also equals the distance between center point 302A of the main spar 302 and the center point 303A of the slat spar 303. Arc, line 405A indicates the angle of deflection between the horizontal reference line 405 and connects the wing center line 306A of the slat hinge arm 306. This is a constant angle established by the position of the centerline 306A of the slat spar relative to the center point 302A the main spar 302 (see FIG. 4B) when the slat is fully retracted.

FIG. 4A illustrates nozzle area 308, the space between the inner surface of the slat 403 and the outer surface, or skin, of the wing 410. The lower 402A and upper 402B surfaces of the wing are identified for reference purposes,

The mounting assembly 301 connects the wing 401 to the slat; the main spar bracket 304 is riveted to the main spar and the slat spar bracket is riveted to the slat spar 303. The slat hinge is functionally securely connected to each spar by means of a corresponding spar bracket 304 and 305. Line 406 indicates both the position and width of the first opening 406 of the spar slot 411. Line 407 similarly represents both the width and position of the top opening 407.

FIG. 4B illustrates the cross section view 401 of the wing 404 with the wing slat 403 fully retracted. The spar slot 411 is compressed into a narrow space having minimal to no effects on the aerodynamics of the wing. The bottom opening 406 of the spar slot 411 is reduced to less than 1 inch (2.54 cm). In the retracted position, the slat has minimal chord line or lift. The outer surface 412 of the skin of the slat contacts the skin of the wing 410, thereby reducing the top opening of the slot effectively to zero. Retraction of the slat does not affect the relationship between the center point 302A of the main spar 302 and the center point 303A of the slat spar 303, as indicated by the angle 306A of the main spar 302 and the center point 303A and the center point of the slat spar 303, as indicated by the angle between the reference horizontal line 405 and the centerline 306A between the main and slat spar center points 302A and 303A, respectively. Angles 306 and 306A (FIG. 4A FIG. 4B, respectively) are the same.

FIG. 4A and FIG. 4B, respectively, provide side views of the slat 403 fully deployed and in the retracted position. The figures do not illustrate how deployment/retraction is initiated or occurs. FIG. 4A shows clearly that the slat moves forward and remains at a right angle (parallel) to the main spar 302 (and to the leading edge of the wing). Comparison of the center point of the main spar 302A and slat spar 303A illustrate the relatively lower position of the slat spar 303 with respect to the main spar 302. The slope of the line describing this relationship is described by arc 306A and by arc 405A, note, the arcs are the same, and as the slat deploys, it moves forward and downward on a constant plane described by these arcs.

FIG. 4C illustrates the movement of the slat spar as it is positioned in the fully retracted position 303 versus the position of the slat spar in the fully deployed position 303A.

The slat spar 303/303A is physically connected to the main spar 302 and the main spar 302 anchors the wing to the fuselage of the aircraft. As the slat spar 303/303A moves forward/outward, it remains parallel to the main spar. This relationship is established by the slat hinge arm 306/306A. As the slat spar moves forward and downward, the slat arm hinge 306/306A follows the arc 418, thereby holding the slat spar 303/303A in its parallel relation to the main spar 302. Note, each slat spar is connected to the main spar by a pair of mounting assemblies 301, otherwise, or the parallel relationship could not be maintained. Maximum deployment is attained when, as illustrated by FIG. 4C, the slat hinge arm 306 is limited to slightly less than 90 degrees to the main spar 302, and, by way of example, not absolute limitation, from about 87 to 89.5 degrees. The lateral movement of the slat spar 303A is indicated by line 416, which reflects the distance between reference point 415 on the fully retracted slat spar 303 and the same reference point 415 on the fully deployed slat spar 303A. Movement forward, at slightly less than 90 degrees to the slat spar is indicated by line 417.

The basic function of an automatic wing slat is relative simple to describe. In normal flight when air speed approaches close to stall speed as a result of increased angle of attack or reduction in power, pressure aerodynamic conditions is reduced and the physical (aerodynamic) forces the retain the retain the fully automatic slat in its retracted position are altered and compensating forces tend to force the leading edge of the slat forward and, with the fully automatic slat herein disclosed, laterally outboard (towards the wing tip), along the leading edge of the wing. The slat moves to a fully deployed position, thereby increasing lift and permitting at reduced air speed and averting stall/spin conditions. When air speed is increased by reducing the angle of attack or increasing power, aerodynamic conditions are effectively reversed and the slat is fully, automatically retracted along the same lines at which it was deployed.

Fully automatic slats described herein are most commonly light and responsive to modest changes of pressure along the leading edge of the wing. Balance of the slat and positioning of the slat spar of its fully retracted position, slightly below the center point of the center line of the wing main spar (and/or center line of the wing) are significant factors in deployment of the slat.

Minimum flight speed, short take-off and landing distances (and low speeds), and low stall speeds are direct functions of the cross section shape of the wing, plus lift effects related to deployment of slats (and of wing flaps). Consistently reliable performance of the automatic slats requires a hinge device that does not stick or bind in response to movement of the slat in deployment or retraction and that securely attaches the slat to the wing. By design, the mounting assembly 301 herein described and claimed fully and uniquely satisfies these requirements.

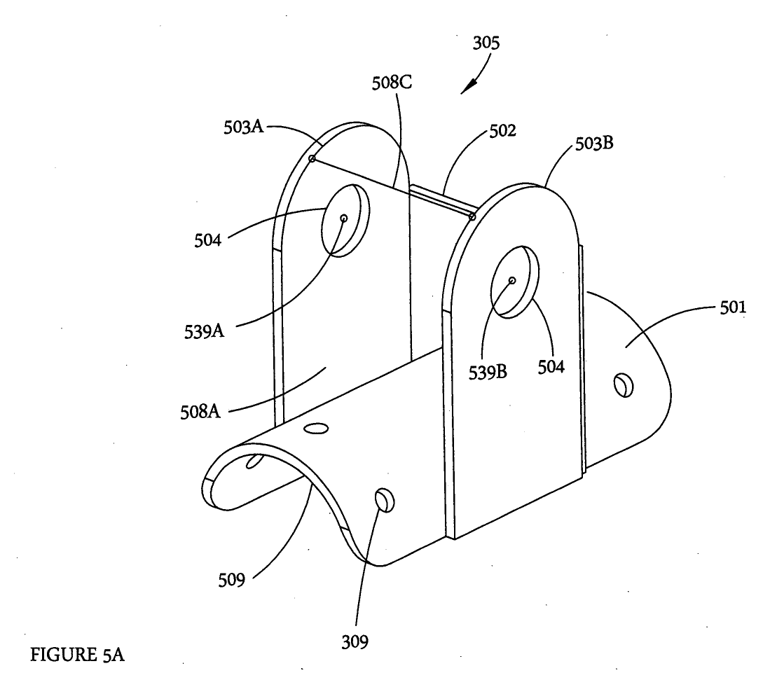

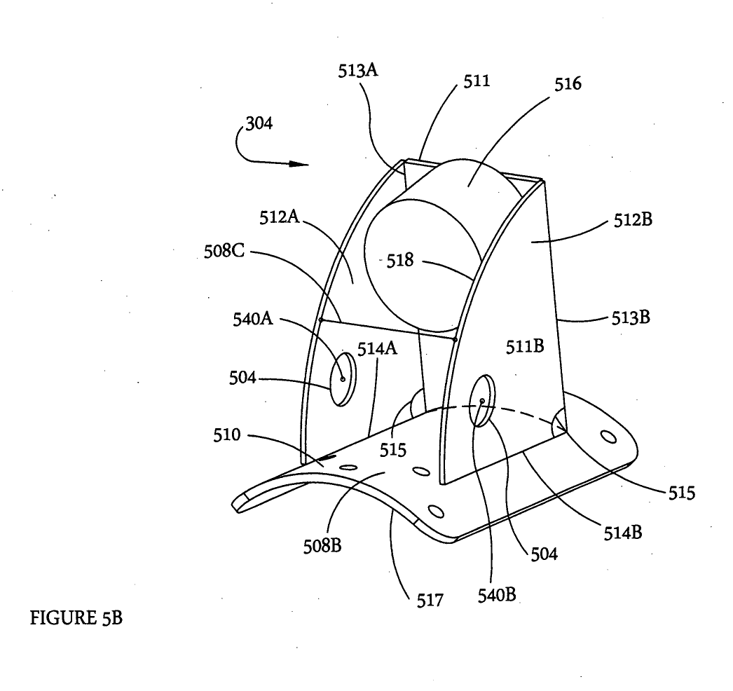

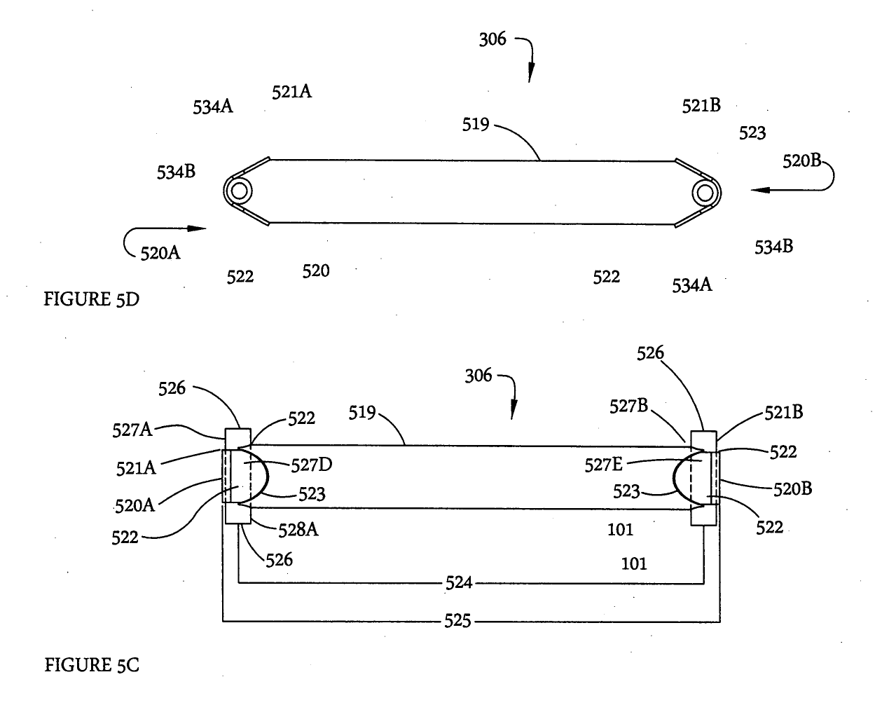

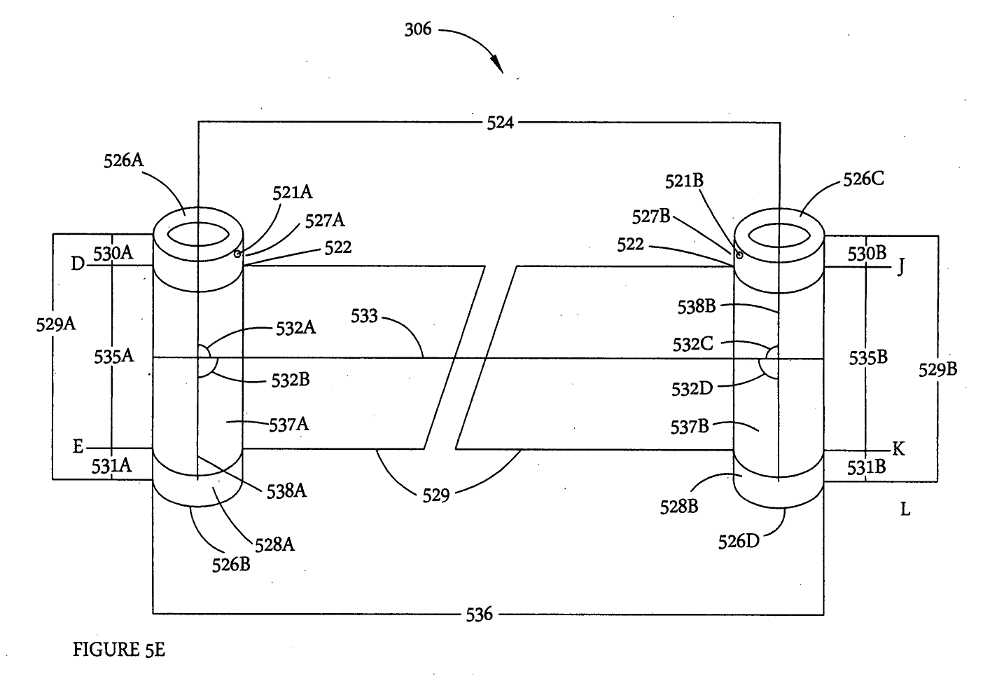

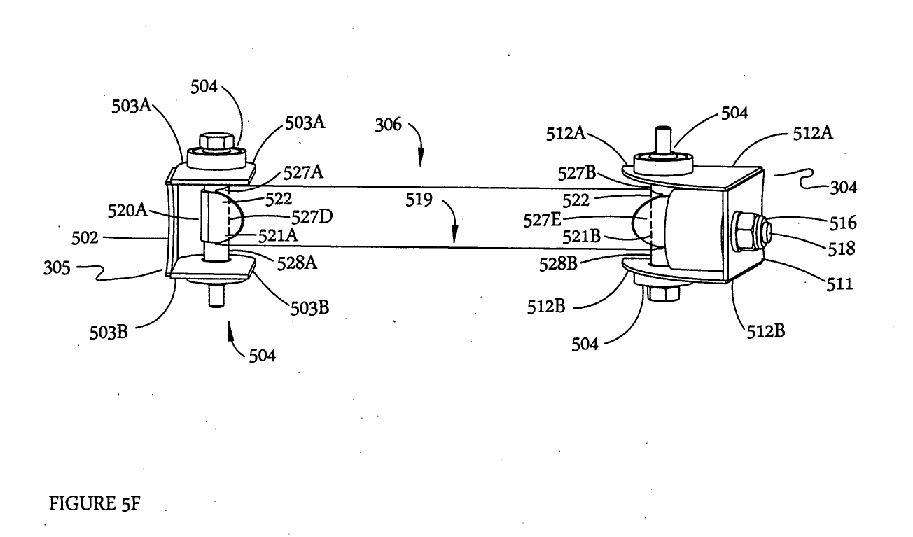

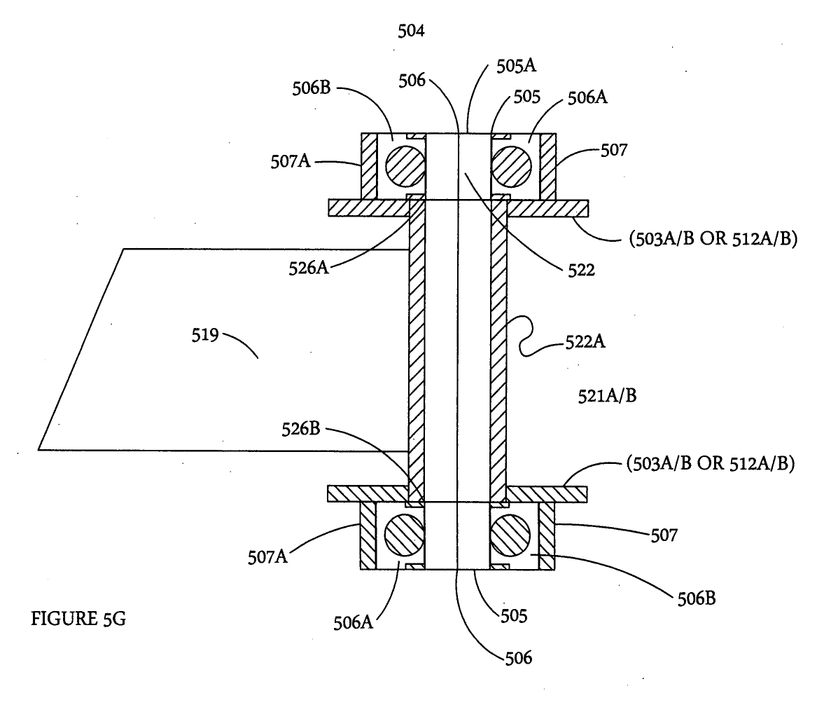

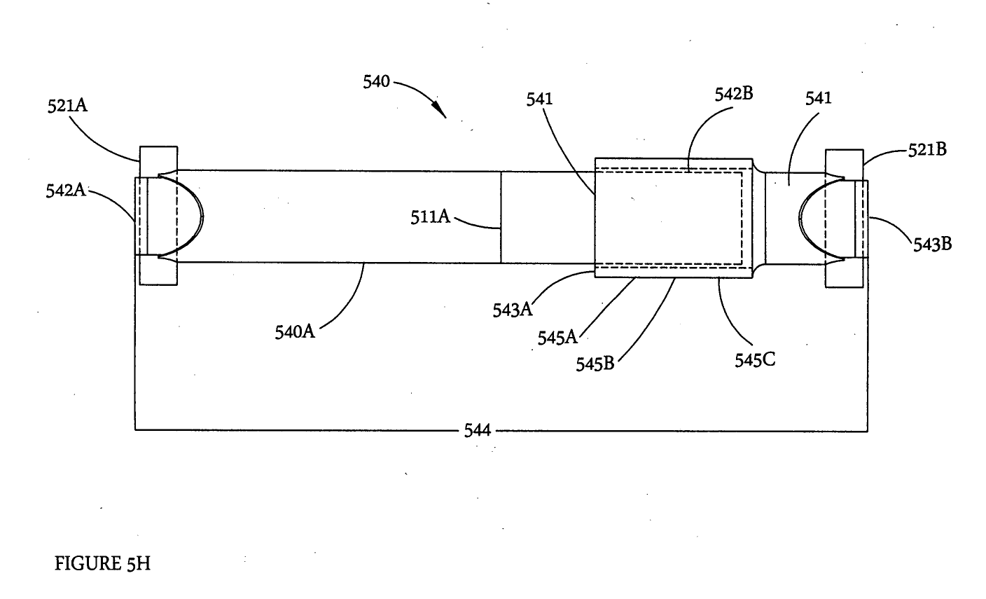

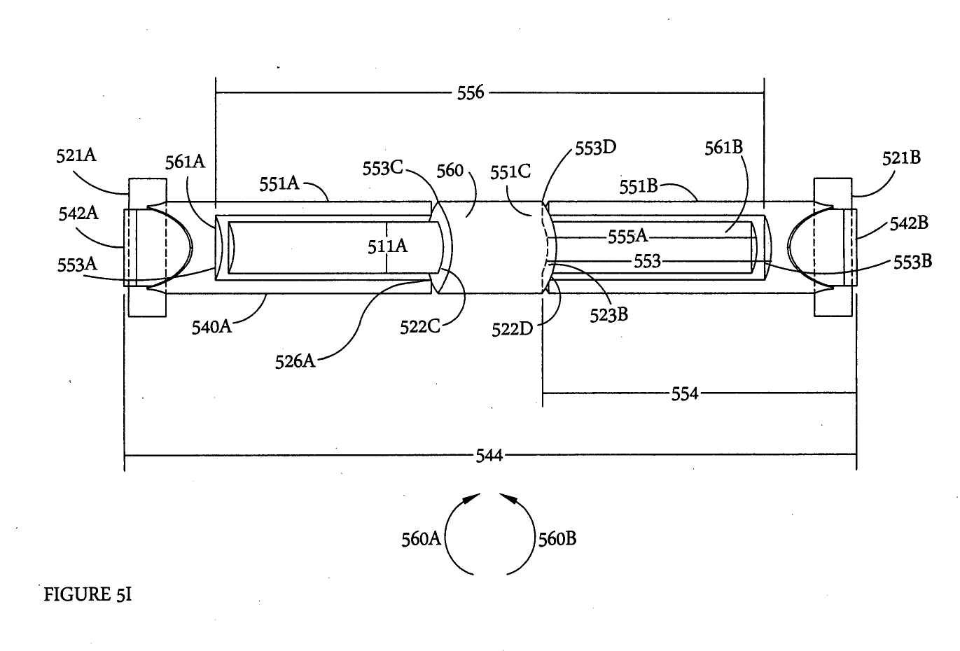

Each of the three main elements of the mounting assembly 301—the main spar bracket 304, the slat spar bracket 305, and the slat hinge arm 306 comprise several parts or sections. These parts or sections are described and explained below, in conjunction with FIGS. 5A-J.

The slat spar bracket 305, FIG. 5A, is connected to the slat spar 303 with stainless steel rivets or comparable means known to those skilled in the art. The slat spar bracket 305 comprises a base 501, extending vertically upward from slat spar bracket base 501 are the back wall 502 and the first and second bracket side walls 503A and 503B, respectively. Both the first and the second slat bracket side walls 503A and 503B, respectively, comprise an axle pivot unit 504. The main spar bracket 304, FIG. 5B, is similar in many aspects to the slat spar bracket 305.

The main spar bracket 304 comprises a main spar bracket base 510, a main spar bracket back wall 511, and a first and a second main spar side wall 512A and 512B. Both the first and the second main spar bracket side walls 512A and 512B comprise axle pivot units 504 as described-above for slat spar bracket side walls 503A and 503B.

The edge of the main spar bracket back wall 511B and the edges of the first and second main spar bracket 514A and 514B, respectively, are connected to the main spar bracket base 510. Angle 515 shows that the back edge of the first and second side walls 513A and 513B are at a common angle slightly less than vertical (for example, not as a limitation 98.5 degrees). As a result, the main spar bracket back wall 6511 is at the same angle. In addition, a rubber bumper 516 in mechanically connected (bolt or other comparable means) to the back wall 511. The main spar bracket back wall 511 and the side walls 512A and 512B define and limit define and limit the open-front axle pivot unit 504. The angle of the back wall of the main spar bracket limits the vertical travel of the slat arm hinge to less than 90 degrees.

The arc, arrow 517, of the main spar bracket base 510 is a segment of a circle with the radius equal to the radius of the main spar. The width 508C of the axle pivot housing 508A and 508B and the corresponding width of the axle pivot unit are identical, FIG. 5A and FIG. 5B.

The slat hinge arm 306, FIGS. 5C and 5D, comprises the third element of the mounting assembly. The slat hinge arm 306 comprises a tubular structural arm unit 519, with a first end 520A and a second end 520B and further comprise a first and second axle 521A and 521B, respectively. Each axle 521A and 521B is divided into an upper section 527A and 527B, a lower section 528A and 528B, and an interstitial section 527D and 527E. The length of the upper sections are identical and equal to the length of the lower sections, and the length of the interstitial 527D and 527E and equal and greater than the length of the upper and lower sections. The overall length of the axles 521A and 521B is equal to, or minimally greater than the width of slat spar bracket 305 and main spar bracket 304 which lengths are equal.

The first pivot axle 521A traverses the structural arm 519 at the first end 520A and is secured by and to the arm; an axle clamp or re-enforcement strap 523 extends around the axle to further secure it. The second pivot axle 521B is identically connected to the second end 520B of the structural arm 519. The pivot axles are at a right angle to the structural arm 519 and are mutually parallel.

The outside 534A and inner 534B walls of the first and second pivot axles 521A and 521B define and limit the lumen 507 through which a connector bolt 507 traverses the axle.

FIG. 5E illustrates various dimensions of the slat hinge arm 506. The overall length of the structural arm unit 529 extends from the outer edge of the first pivotal axle 521A to the outer edge of the second pivotal axle 521B. This length varies by way of illustration, not limitation from 4.5 to 10.5 in (10 to 25 cm). The effective length of the structural arm unit 529, line 524 (points m-n), is the distance between the first and second pivotal axles 521A and 521B, respectively. This distance establishes the distance the distance between the slat spar bracket and the main spar bracket 305 and 304, respectively. This distance, line 524, is the critical distance in the overall length 536 of the structural arm unit 306.

The dimensions of the first and second pivotal axles 521A and 521B, respectively, are identical. For the first pivotal axle 521A the overall length, line 529A (points a-b) varies from 2 to 4 in (5 to 10 cm) by way of example, not limitation. The length of the first upper segment 529A, line 530A (points c-d) varies from less than 0.5 to about 1.5 in (1.3 to 7.0 cm), by way of example. The length, line 531A (points e-f) of the first lower segment 528A is identical to the first upper section 527A. The length, line 535A (points d-e) of the interstitial segment 537A is generally, approximately twice the length of either of the first upper 521A or first lower 528A segment segments 528A.

The center line 538A of the first pivotal axle 521A is at a right angle, vertically upward, arc 532A and vertically downward arc 532B from the center line 533 of the structural arm unit 529.

For the second pivotal arm unit 521B the overall length, line 529B (points g-h) is identical to the first pivotal arm unit. The length line 530B of the upper segment 527B of the second pivotal arm unit 521B is identical to the corresponding segment of the first pivotal arm unit 521A. Similarly, the length line 531B (points k-l) of the second lower segment 528B and the length line 535B of the second interstitial segment 537B are identical to the corresponding segments of the first pivotal arm units. The center line 538B of the second pivotal axle unit 521B is at a right angle to the center line 533 of the structural arm unit 529 and parallel to the center line 538A of the first pivotal axle 521A, arc 532C and arc 532D illustrating right angle relationships between horizontal and vertical center lines.

FIG. 5F provides a schematic view of a fully assembled mounting assembly 306 with the slat spar bracket 305 positioned at the first end 520A of the structural arm unit 519 and the functionally, pivotally secured to the first pivotal axle 521. The main spar bracket 304 is positioned at the second end 520B of the structural arm unit 519 and also functionally, pivotally secured to the second pivotal axle 521B. One skilled in the art recognizes that designation of first and second end or upper and lower units is arbitrary and used herein for convenience of identification of specific parts and/or locations. Such reference can be interchange or otherwise modified without modifying or extending the scope or purpose of the invention.

The first pivotal axle 521A is divided into three segments: the first pivotal axle upper axle segment 527A, the first pivotal axle lower segment 527B, and the connecting first pivotal axle interstitial segment 527D. Similarly, the second pivotal axle 521B is divided into three segments—a second pivotal axle upper section 527B, a lower segment 528B, and an interstitial segment 527E.

The upper segment 527A of the first pivotal axle 521A and the lower segment 527B of the first pivotal axle 521A are positioned in the axle pivot housing 508A of the slat spar bracket 305. The first pivotal axle 521A is positioned at right angles to the first and second side walls 503A and 503B, respectively, and the end face of the upper segment 527A and the end face of the lower segment 527B of the first pivotal axle 521A physically and functionally engage the bearing assemblies 506 in the corresponding axle pivot units 504.

Similarly, the upper 527B and lower 527B segments of the second axle pivotal housing 508B of the main spar bracket 304. The second pivotal axle 521B is positioned at right angle to the first and second side walls 512A and 512B respectively of the main slat bracket 304. The end faces of the upper and lower segments of the second pivotal axle 521B physically contact and functionally engage the bearing assembly 506 in the corresponding axle pivot unit 504.

FIG. 5G summarizes and illustrates details of positioning a pivotal axle in a spar bracket. In the following, index numbers are included in a single figure. Although the slat spar bracket 305 and the wing spar bracket have structural and functional differences that have been discussed above, with respect to the basic functions of anchoring and providing the foundation for pivoting of the pivotal axles that is essential in automatic deployment and retraction of the slats, the brackets are identical; thus the following descriptions and discussion based on a single representation including comparable numbering for both brackets 305 and 304.

As summarized in FIG. 5G, a members of a pair of axle pivot units 504 are positioned on and structurally are part of the slat spar bracket 305 and the wing spar bracket 304. A member of each pair is positioned with the first bracket side wall and the other member with the second bracket side wall, 503A/503B and 512A/512B, respectively for the spar and wing bracket. The members of each pair of axle pivot units 504 are positioned at precisely located center points on opposing side walls 539A/B and 540A/B respectively for side walls 503A/B and 512A/B. Each axle pivot unit 504 extends slightly from the outer side of the side wall of the bracket 305 or 304. A pivot axle chase 505 traverses the bearing assembly 506 pivot unit 504 and corresponding bracket side wall. The bearing assembly 506 is a major functional element of each axle pivot unit 504. The bearing assembly is positioned in the bearing unit such that it extends effectively to the inner surface of the bracket walls. The pivot axle chase 505 extends to and is aligned with the pivot axle chase 522. Each end of a pivotal axle is in functional contact and communication with the bearing element of the corresponding axle pivot unit when the axle is positioned between the bracket walls in an axle housing unit. This position is secured by a connector that traverses the axle and secures each end of the connector to the external face of the axle pivot unit.

The details of the axle pivot unit 504 and are best appreciated through FIG. 5G, starting at the center of the unit and moving to the perimeter. The unit comprises a connector bolt chase 505 that traverses the bearing assembly 506. The bearing assembly 506 is positioned such that the open lumen formed its inner wall 506A describes and limits the connector bolt chase 505. The outer wall 506B comprises the inner limits of the bearing cup 507, and the outer surface of the bearing cup 507A comprises the outer surface of the bearing assembly 506.

The outer surfaces of the side wall, the connector bolt chase 505 effectively become the center line for the larger axle chase 522 and functionally engage the bearing assembly.

A connector bolt 505A traverses the bearing assembly positioned on the side walls and them axle chase 522. The axle connector bolt 522 is secured threaded connectors at opposite ends, and secures the axle pivot unit, spaced by and secured against the opposite end of the pivotal axle.

One skilled in the art recognizes and understands that the bearing assembly 506 of the axle pivot unit 504 can be replaced with bushing assembly without significant modification of the structure or function of the axle pivot unit 504. Such modifications do not alter the scope or intent of the invention and are anticipated as a part of the invention.

The basic positioning and functions of the axle pivot unit remain unchanged. Each axle pivot unit remains a part of the slat spar 305 or main spar 306 bracket and positioned as previously described. The axle pivot unit chase 505 remains essentially unchanged; with the bushing assembly (rather than the bearing assembly), the axle pivot chase traverses the bushing assembly. The bushing assembly assumes the assumes the functions of the bearing assembly in the axle pivot unit. The pivot axle chase 505 (now involving the bushing assembly) extends to and is aligned with the pivot axle chase. Each of the axles is in functional communication and contact with the corresponding axle pivot unit through the bushing assembly (rather than through the bearing assembly). Opposing axle pivot units 504 and supporting bracket side walls are mechanically connected by the connector that also aligns the pivot axles and secures the full assembly.

The function of the axle pivot unit, specifically the function of the physical interface of the bearing (or bushing) and the pivot axle is to promote and ensure minimum friction and impedance of the essential pivoting of the pivot axle as the structural arm carries the slat outward or inward as it is deployed or retracted.

The fully automatic slat moves from its fully retracted position on the leading edge of the wing to a fully deployed position, with the slat outward (forward) and at a slight, constant angle downward from the center line of the wing. The leading edge of the slat moves uniformly forward, and simultaneously it moves laterally outward (away from the fuselage. Aerodynamic forces affecting the leading edge of the of the slat in response to reduced air speed and/or increased angle of attack, including air flow through the nozzle area between the interior surface of the slat and the leading edge of the wing expressed as reduced pressure on the leading edge of the slat that pulls the slat forward and trigger deployment of the slat. When conditions are reversed, increased air speed or reduced angle of attack, the process is reversed and the slat fully retracts.

The automatic slat assembly must function consistently; slats must respond uniformly to pressure changes, and each element of the assembly must be secured appropriately, to a spar or to form the connection between spars.

Achieving a superior automatic slat starts with the connection of the slat and wing. The foundation of this is the connection of the spar and wing brackets. The bracket base connects the bracket to the spar or wing. The bracket bases are curved to fit precisely to the curvature of the spar to which they are attached. This provides optimum surface contact and configuration for riveting, or otherwise connecting the bracket to the slat spar or wing spar.

The bracket bases are centered on a common line between the center points of the slat spar and the wing spar. For any designated distance this spacing of the bracket bases is the minimum distance between any two points on opposing circles (or spars). This spacing of the spar brackets allows the axle pivot units associated with each bracket so that axle pivot units of the slat spar bracket are parallel to axle pivot units of the of the wing spar bracket and each is at the same right angle of the structural arm unit that connects a pair of pivot axles. The positioning of the pivot axles and positioning of the top and bottom of each with a corresponding bearing assembly ensures minimum potential binding or other obstacles to the free travel of the unit as it moves an established arc in deployment or retraction of the slat. Because individual slats are not interconnected, consistent, uniform travel in deployment and retraction in response to changes in air pressure is essential for safety in flight. The angle of the back wall of the wing spar bracket is positioned slightly less than vertical; this limits the maximum deployment (travel) of the slat by limiting the maximum angle of the structural arm unit to slightly less than 90 degrees. This limitation has minimal if any impact on effectiveness of the slat, but it ensures that the slat will not over travel and fail to retract properly.

Ideally, the wing and slat spars are uniformly round and effectively parallel such that the equal distances and parallel relationships described above are satisfied. From time-to-time, slight variations occur that are not detected in spite of rigorous inspections and quality control of materials. Such deviations do not represent a risk to normal, safe flight, but uncorrected, they may affect slat deployment/retraction.

The solution is a modified structural arm unit 540. This modified unit 540 may replace the previously structural arm unit in one of the pair of mounting assemblies for installation of an individual slat.

The modified structural arm unit 540 provides means to change the length of the structural arm 540. Note, functionally the modified structural arm 540 is the same as the structural arm unit 519. It is renumbered here because there are specific structural differences that separate it from the basic unit 519. The first and second pivotal axles 521A and 521B, respectively, retain their location and functions.

The modified structural arm unit 540, FIG. 5H, comprises two segments: the insert segment 540A and the sleeve segment 540B. The sleeve segment 540B comprises an insert chamber 541 the diameter of which, line 541A, is equal to the outer diameter of the insert segment 540A. The insert, segment 540A has a first end 542A which is also the first end of the modified structural arm unit 540 and a second end 542B. Similarly, the sleeve segment 540B has a first end 543A and a second end 543B which is the second end of the modified structural arm unit 540.

The overall length, line 544, of the modified structural arm unit 540 can be increased or decreased by moving the insert segment 540A further into or out of the insert chamber 541. This is clearly by the position of the second end 542B of the insert, segment 540A relative to the three reference points 545A, 545B, and 545C positioned on the insert chamber 541 for reference purposes only.

As shown in FIG. 5H, the second end 542B of the insert segment 540A is at reference point 545B. Moving the second end 542B to reference point 545A increases the overall length, line 544, of the of the modified structural arm unit 540 by a distance equal to the distance between reference points 545B and 545A. Starting again at reference point 545B, moving the second end 542B inward to the third reference point 545C shortens the overall length, line 544, of the of the modified structural arm unit 540. In addition, the two segments 540A and 540B can be rotated to correct binding from non-parallel pivotal axles 521A/B.

The final adjustment allowed by the modified structural arm unit 540 is accomplished when the mounting assembly 301 is installed in the aircraft with the slat in a fully retracted position. The seam between the trailing edge of the slat and the lower surface of the wing is parallel through its entire length and the opening is minimal. When fully deployed, this parallel condition is maintained. In addition, the optimum ratio between the distance between the trailing edge of the slat and the lower wing surface and the upper edge of the slat and the upper wing surface when the slat is fully deployed is established and maintained at 2.5 to 3.0:1.00.

One skilled in the art recognizes that a variety of modifications to adjust (lengthen of shorten) the structural arm 540 or produce a modified arm as illustrated in FIG. 5H are possible. FIG. 5I illustrates a second, general approach to adjust the length of the structural arm. This variation and combinations derived from it are considered to be part of the claimed invention.

In FIG. 5I, the second modified structural arm unit 550 is divided into three segments, the first segment 551A, comprising the first end 542A and the first pivotal axle 521A; the second segment 551B comprising the second end 542B and the second pivotal axle 521B The first and second segments 551A and 551B, respectively, each comprise a second end 552A and 552B, respectively, and each of the second ends 552A and 552B comprises a first and a second threaded socket 553A and 553B, respectively. The third, interstitial segment 551C comprises a body 560 and a first 561A and a second 561B threaded adjustment rod.

The threaded adjustment rods 561A and 561B are adapted functionally to engage the corresponding threaded sockets 553A and 553B. Rotation of the body 560 of the interstitial segment 551C in one direction moves both threaded adjustment rods 561A and 561B inward with respect to the corresponding threaded sockets 553A and 553B, thereby shortening the overall length 544 modified structural arm.

Rotation of the body 560 in the opposite direction moves the moves the threaded adjustment rods outward, with respect to the threaded sockets 553A and 553B, thereby lengthening the modified arm. The overall length 556 of the interstitial segment 551C is greater than one half the overall length 544 of the modified structural arm 560. The lengths (or depth) of the threaded sockets 553A and 553B are equal and less than the lengths of the first and second segments 551A and 551B.

In an alternative, third configuration, the body 560 of the interstitial segment comprises the first and second threaded sockets and the first and second segments comprise the threaded adjustment rods. In this alternative, the length of the interstitial segment 551C is less than one half of the overall length and the lengths of the first 551A segment and of the second 551B segment are equal and greater than one fourth the overall length.

The preceding examples and illustrations represent specific combinations of parts and elements of a mounting assembly for fully automatic slats. These examples and illustrations can be recombined into numerous additional combinations of the same invention and such combinations are anticipated by the invention. As a result, the following claims should be accorded the broadest interpretation consonant with the art in its broadest sense.

One skilled in the art recognizes many combinations to modify the structural arm and all of such combinations are anticipated by the above examples.

I claim:

1. A spar mounting assembly comprising a slat spar bracket, a main spar bracket, and a slat hinge arm; wherein, said slat spar bracket comprises a base, a first and a second side wall, and a back wall, wherein, said first and second side walls are structurally connected to adjacent edges of said back wall and said first and second side walls and said back wall are structurally connected to said base and comprise an axle pivot housing, and further, wherein, said first and said second slat spar bracket side walls each comprises an axle pivot unit positioned and secured in and made a part of each of said side wall and functionally adapted to engage a rotational axle; and wherein said main spar bracket comprises a base, a first side wall and a second side wall, and a back wall, wherein said first and said second side walls are structurally connected to said back wall, and said first and second side walls and said back wall are structurally connected to said base and comprise an axle unit housing, and further wherein said back wall comprises a stopper physically connected to the inner face of said back wall, and wherein said first and said second side walls of said main spar each comprise an axle pivot unit positioned and secured in and made part of each of said first and second side walls, and functionally adapted to engage a rotational axle; and further, wherein each of said axle pivot units positioned on said first and second side walls of said slat spar bracket is aligned on a common line vertical to the face of said first and second side walls and passing through the center point of each of said axle pivot units; and further, wherein, each of said axle pivot units positioned on said first and said second side walls of said main spar bracket is aligned on a common line vertical to the face of said first and said second walls and passing through the center point of each; said slat hinge arm comprises a structural arm unit comprising a first and a second end, and an effective length, wherein each of said first end and said second end comprises a structural arm unit comprising a pivotal axle wherein said pivotal axles are parallel one to the other and at a right angle to the center line of said structural arm unit, and wherein each of said pivotal axles is positioned in the corresponding axle pivot housing such that one end of said pivotal axle physically and functionally engages a bearing assembly in one side wall of said axle pivotal housing, and the second end engages the second bearing assembly in said axle pivotal house and further wherein a connecting bolt traverses said first bearing assembly, said pivotal axle, and said second bearing assembly to secure said structural axle to said spar bracket and said main bracket; further, wherein said pivotal axles are connected respectively to said slat spar bracket and to said main spar bracket, thereby physically and functionally connecting the slat to the wing; and wherein the members of pairs of pivot axles are mutually parallel, and finally, wherein the bases of said slat spar bracket and said main spar bracket are centered on a common center line connecting the center points of said slat spar and said main spar such that the distances between said slat spar bracket and said main spar bracket is the shortest possible and the effective length of said structural arm is minimal thereby requiring parallel positioning of opposing pivotal axles.

2. The slat mounting assembly of claim 1, wherein both the slat spar and the wing spar are circular in cross-section geometry and wherein the shape of the base of the slot bracket and of the wing spar bracket is adapted to the diameter and configuration of said spars.

3. The slat mounting assembly of claim 1, wherein said slat hinge arm of one member of one pair of mounting assemblies comprises a modified structural arm unit, wherein said structural arm unit comprises two segments: an insert segment and a sleeve segment, wherein the overall length of said slat hinge arm may be adjusted by the position of the insert segment in the sleeve segment.
